(19) United States
(12) Patent Application Publication
(10) Pub. No.: US 2006/0033852 A1
(43) Pub. Date: Feb. 16, 2006

(54) Array substrate, main substrate having the same and liquid crystal display device having the same

(76) Inventor: Dong-Gyu Kim, Yongin-si (KR)

Correspondence Address: MCGUIREWOODS, LLP, 1750 TYSONS BLVD, SUITE 1800, MCLEAN, VA, 22102, US

(21) Appl. No.: 11/189,738

(22) Filed: Jul. 27, 2005

(30) Foreign Application Priority Data
Aug. 13, 2004 (KR) 10-2004-64052

(51) Int. Cl. G02F 1/1343

(52) U.S. Cl. 349/38

(57) ABSTRACT

An array substrate includes a substrate, a plurality of data lines on the substrate, a plurality of scan lines on the substrate, a pixel electrode on the substrate, a shielding common electrode on the substrate, a data test part on the substrate and a shielding common electrode pad on the substrate. The pixel electrode is in a region defined by the data and scan lines adjacent to each other. The shielding common electrode surrounds the pixel electrode. The data test part applies test data voltage to the data lines. A shielding common voltage that has different level from the test data voltage is applied to the shielding common electrode through the shielding common electrode pad.

### CROSS-REFERENCE OF RELATED APPLICATION

The present application claims priority from Korean Patent Application No. 10-2004-0064052, filed on Aug. 13, 2004, which is hereby incorporated by reference for all purposes as if fully set forth herein.

### BACKGROUND OF THE INVENTION

1. Field of the Invention

The present invention relates to an array substrate, a main substrate having the array substrate, and a liquid crystal display (LCD) device having the array substrate. More particularly, the present invention relates to an array substrate capable of improving yield, a main substrate having the array substrate and a liquid crystal display (LCD) device having the array substrate.

2. Description of the Related Art

An LCD panel includes an array substrate, a color filter substrate and a liquid crystal layer. The color filter substrate corresponds to the array substrate. The liquid crystal layer is interposed between the array substrate and the color filter substrate. The array substrate, includes a pixel region and a signal applying region where a data signal and a scan signal are applied.

A data line, a scan line and a pixel electrode are provided in the pixel region. The data line extends in a first direction. The scan line extends in a second direction that is substantially perpendicular to the first direction, and crosses the data line. The pixel electrode is coupled with the scan and data lines. A first driving chip pad and a second driving chip pad are in the signal applying region. A first driving chip applying the data signal is formed on the first driving chip pad. A second driving chip applying the scan signal is on the second driving chip pad.

When a plurality of array substrates are formed on a main substrate, the array substrates are tested to determine operation of lines of the array substrates. The liquid crystal layer is then interposed between each of the array substrates and the color filter substrate. A visual inspection (V/I) process is then performed to test electrical and optical operations of the LCD panel. In the test of the array substrates and the V/I process, a plurality of data lines and a plurality of scan lines are grouped into a plurality of groups, and each of the groups is tested using a test signal.

The tests are complicated and involve many processes. Such complicated and timely testing decreases the yield of the array substrates.

### SUMMARY OF THE INVENTION

The present invention provides an array substrate capable of improving yield.

The present invention also provides a main substrate having the above-mentioned array substrate.

The present invention also provides a liquid crystal display (LCD) device having the above-mentioned array substrate.

Additional features of the invention will be set forth in the description which follows, and in part will be apparent from the description, or may be learned by practice of the invention.

The present invention discloses an array substrate including a substrate having a plurality of data and scan lines that define an area for a pixel electrode to be formed and a shielding common electrode surrounding the pixel electrode, a data tester applying a test data voltage to the data lines, a shielding common electrode pad applying a shielding common voltage having a voltage level that is different from the test data voltage to the shielding common electrode.

The present invention also discloses a main substrate including an array substrate comprising a substrate having a pixel electrode provided in an area defined by a plurality of data and scan lines and a shielding common electrode surrounding the pixel electrode; data tester applying a test data voltage to the data lines, and a shielding common electrode pad applying a test shielding common voltage to the shielding common electrode.

The present invention also discloses a liquid crystal display device including a display panel comprising a switching element, a liquid crystal capacitor, a storage capacitor, a pixel electrode, and a shielding common electrode surrounding the pixel electrode, a driver applying a driving signal to the display panel, and a driving voltage generator applying a common voltage to the liquid crystal capacitor and applying a shielding common voltage to the shielding common electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view showing an array substrate according to an embodiment of the invention.

FIG. 2 is an exploded perspective view showing a pixel shown in FIG. 1.

FIG. 3 is a cross-sectional view taken along a line I-I′ shown in FIG. 1.

FIG. 4 is a plan view showing a main substrate having the array substrate shown in FIG. 1.

FIG. 5 is a plan view showing a test operation performed on the main substrate using an array test part shown in FIG. 4.

FIG. 6 is a plan view showing an LCD panel having the array substrate shown in FIG. 1.

FIG. 7 is a plan view showing a V/I test operation performed on the LCD panel using a V/I test part shown in FIG. 6.

FIG. 8 is a block diagram showing an LCD device having the LCD panel shown in FIG. 7.

FIG. 9A and FIG. 9B are plan views showing pads shown in FIG. 8.

### DESCRIPTION OF THE EMBODIMENTS

It should be understood that the exemplary embodiments of the present invention described below may be modified in many different ways without departing from the inventive principles disclosed herein. The scope of the present invention is not limited to the following embodiments. Rather, the embodiments are provided so that this disclosure will convey the concept of the invention to those skilled in the art by way of example and not of limitation.

Hereinafter, the present invention is described in with reference to the accompanying drawings.

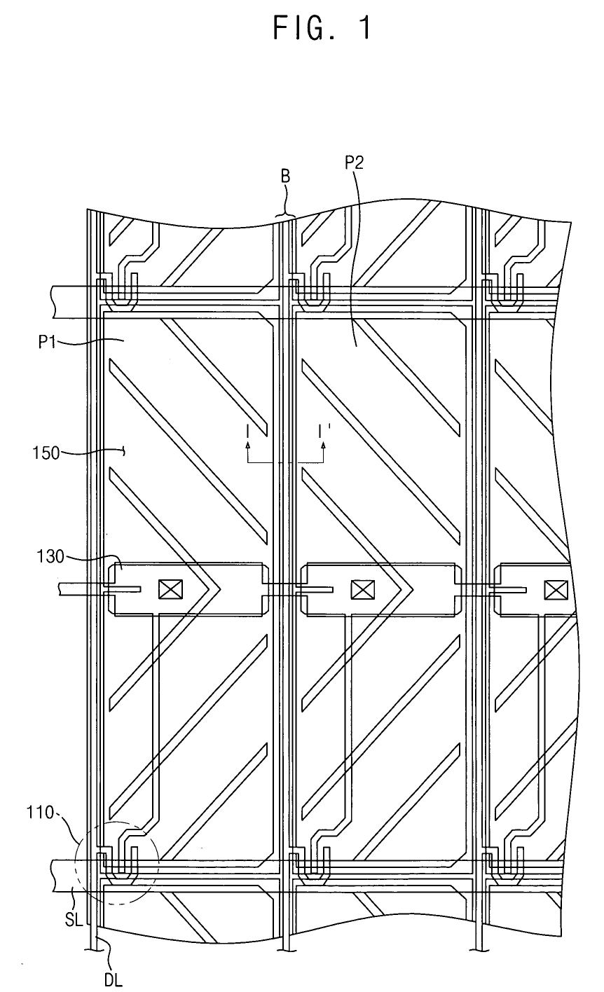

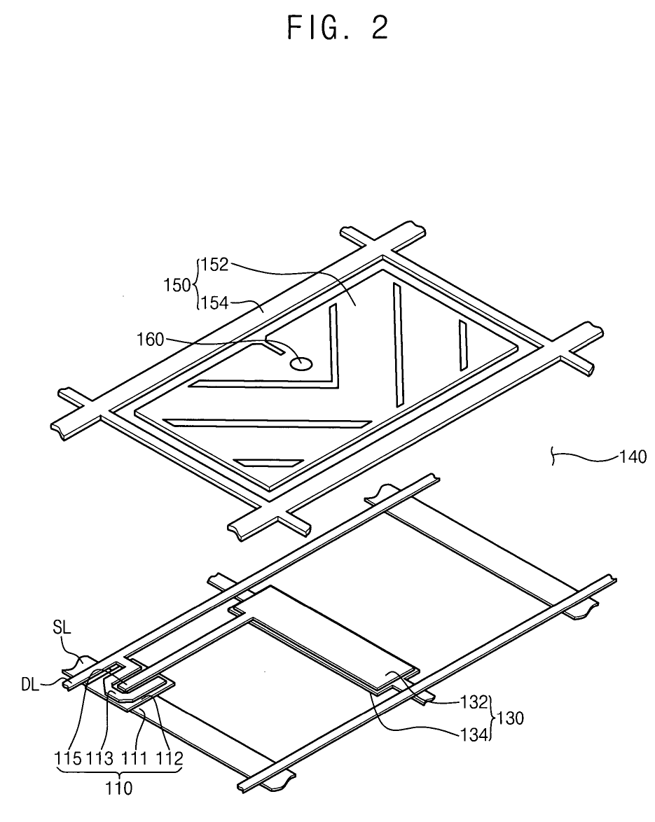

FIG. 1 is a plan view showing an array substrate according to an embodiment of the invention. FIG. 2 is an exploded perspective view showing a pixel shown in FIG. 1.

Referring to FIG. 1 and FIG. 2, the array substrate 100 includes a plurality of data lines DL, a plurality of scan lines SL and a plurality of pixels having a first pixel P1 and a second pixel P2. There may be n number of the data lines DL. There may be m number of the scan lines. There may be n×m number of the pixels. Each of the pixels includes a switching element 110, a storage capacitor 130, and a pixel part 150.

The switching element 110 includes a control electrode 111, a first switching electrode 113 that is a source electrode, and a second switching electrode 115 that is a drain electrode. The control electrode 111 is coupled with one of the scan lines SL that extends in a first direction. The first switching electrode 113 is coupled with one of the data lines DL that extends in a second direction, which is substantially perpendicular to the first direction. The second switching electrode 115 is coupled with one of the pixel electrodes 152. A semiconductor layer 112 is provided between the control electrode 111, the first switching electrode 113, and the second switching electrode 115.

The storage capacitor 130 includes a first storage electrode 132 and a second storage electrode 134. The second storage electrode 134 may be a storage common electrode. The first storage electrode 132 may be coupled with one of the data lines DL. The second storage electrode 134 may be coupled with one of the scan lines SL.

The pixel part 150 includes a pixel electrode 152 and a shielding common electrode 154. According to an embodiment of the invention, the pixel electrode 152 is a first electrode of a liquid crystal capacitor CLC, which includes a first opening pattern that extends in a predetermined direction. The first opening pattern may form an angle of approximately 45 degree with respect to a central line of the pixel electrode 152, which is substantially parallel with the scan lines SL. According to the above described embodiment, the first opening pattern is symmetrical about the central line.

A color filter substrate that corresponds with the array substrate 100 includes a common electrode. The common electrode may be a second electrode of the liquid crystal capacitor CLC. The common electrode may include a second opening pattern that is extended in a predetermined direction. According to an embodiment of the invention, the second opening pattern forms an angle of approximately 45 degree with respect to the central line of the pixel electrode 152. The second opening pattern may be aligned such that it is symmetrical about the central line. Further, the second opening pattern may be alternately arranged with the first opening pattern so that the second opening pattern does not overlap with the first opening pattern.

In the above described embodiment, the array substrate 100 and the color filter substrate form a LCD device of patterned vertically aligned (PVA) mode which increases a viewing angle of the LCD device. An electric field formed in the liquid crystal capacitor CLC is distorted by the first opening pattern and the second opening pattern to increase a viewing angle of the LCD device.

The shielding common electrode 154 may be formed from a same layer as the pixel electrode 152. The shielding common electrode 154 surrounds the pixel electrode 152 and has a matrix like shape. A voltage is not applied from the data lines DL to the pixel electrode 152. For example, the shielding common electrode 154 prevents voltage from being applied to the pixel electrode 152 from the data lines DL. Adjacent pixel electrodes 152 are spaced apart from each other by the shielding common electrode 154 so that a black matrix is provided between the pixel electrodes 152, which decreases leakage or light.

An organic insulating layer 140 may be formed between the switching element 110 and the pixel part 150.

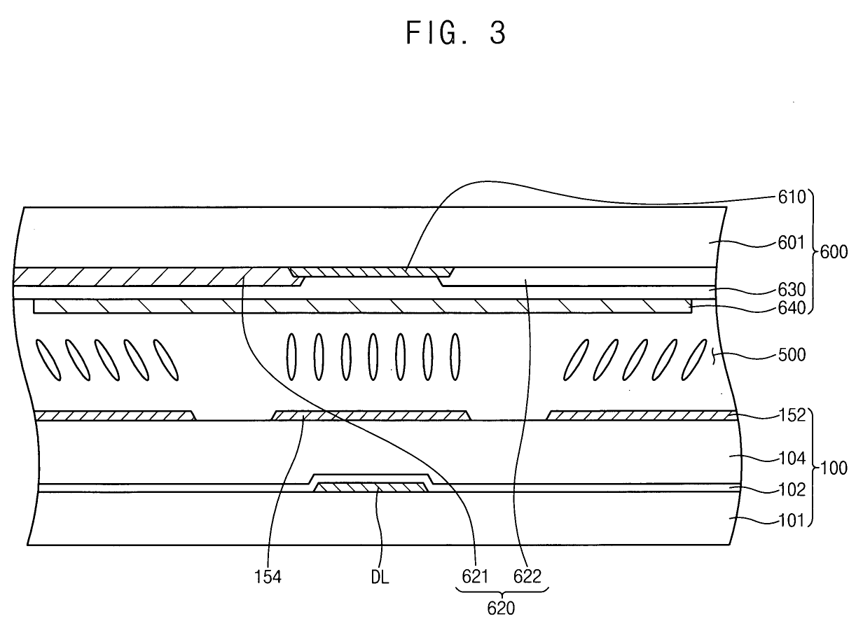

FIG. 3 is a cross-sectional view taken along a line I-I′ shown in FIG. 1.

Referring to FIG. 2 and FIG. 3, the LCD panel includes the array substrate 100, the color filter substrate 600 and a liquid crystal layer 500.

One of the data lines DL is between the first pixel P1 and second pixel P2, which are positioned adjacent to each other. Each of the first pixel PI and second pixel P2 includes the switching element 150 and the storage capacitor 130. According to an embodiment of the invention, the switching element 150 may be a thin film transistor.

The control electrode 111 may be formed from a gate metal layer formed on a first transparent plate 101. The gate metal layer is formed at a metal, such as aluminum, copper, etc. The control electrode 111, the scan lines SL and the second storage electrode 134 are formed from the gate metal layer.

A gate insulating layer (not shown) is formed on the first transparent plate 101 having the control electrode 111, the scan lines SL, and the second storage electrode 134. The gate insulating layer (not shown) may be formed with an insulating material, such as silicon nitride, silicon oxide, etc. The semiconductor layer 112, which may include an active layer and an ohmic contact layer, is formed on the gate insulating layer (not shown).

A source/drain metal layer is formed on the gate insulating layer (not shown) having the semiconductor layer 112. The source/drain metal layer is patterned to form the first switching electrode 113, the second switching electrode 1 1 5, the data lines DL, and the first storage electrode 132. A passivation layer 102 may be formed on the gate insulating layer (not shown). An insulating layer 104 may be formed on the passivation layer 102, however it is understood that the insulating layer 104 may be omitted.

The insulating layer 104 may include an inorganic insulating material such as silicon nitride, silicon oxide, etc., and an organic insulating material, such as acryl resin, Teflon, benzocyclobutene (BCB), cytop, perfluorocyclobutane (PFCB), etc. The insulating layer 104 should have a low dielectric constant. A contact hole 160 may be formed in the passivation layer 102 and the insulating layer 104 so that the second switching electrode 115 is exposed through the contact hole 160.

A transparent conductive layer may be formed on the insulating layer 104. The transparent conductive layer may include a transparent conductive material, such as indium tin oxide (ITO), indium zinc oxide (IZO), indium tin zinc oxide (ITZO), etc. The transparent conductive layer may be patterned to form the pixel electrode 152 and the shielding common electrode 154. The exposed second switching electrode 115 is coupled with the pixel electrode 152 having the transparent conductive material.

The shielding common electrode 154 surrounds the pixel electrode 152. The shielding common electrode 154 is wider than each of the data lines DL. The shielding common electrode 154 may have a matrix like shape.

The color filter substrate 600 includes a second transparent plate 601, a black matrix 610, a color filter 620, an overcoating layer 630 and a common electrode 640. The color filter substrate 600 may be combined with the array substrate 100 to receive the liquid crystal layer 500. The black matrix 610, which may be formed on the second transparent plate 601, blocks light that leaks between the pixels. The black matrix 610 may correspond to either the data lines DL or the scan lines SL. Alternatively, the black matrix 610 may correspond to both the data lines DL and scan lines SL.

The color filter 620 may include a red color filter portion 621, a green color filter portion 622 and a blue color filter portion (not shown). The color filter 620 is provided in regions defined by the black matrix 610. For example, the red color filter portion 621 corresponds to the first pixel P1 and the green color filter portion 622 corresponds to the second pixel P2.

The overcoating layer 630 is formed on the color filter 620 to planarize a surface of the second transparent plate 601 having the black matrix 610 and the color filter 620. The common electrode 640, which may be formed on the overcoating layer 630, receives a common voltage that is provided to the color filter substrate 600. The common electrode 640 is a common electrode of the liquid crystal capacitor CLC.

The normal mode of the liquid crystal layer 500 is black. When voltage is applied to the pixel electrode 152 through one of the data lines DL and the common electrode 640, an arrangement or orientation of a liquid crystal in the liquid crystal layer 500 varies or changes in response to the electric field applied thereto, and thus a light transmittance of the liquid crystal layer 500 changes to display an image.

A reference common voltage OV is applied to the common electrode 640 of the color filter substrate 600 and the shielding common electrode 154 of the array substrate 100. An arrangement of the liquid crystal layer 500 between the common electrode 640 and the shielding common electrode 154 does not change, therefore black remains displayed on the shielding common electrode 154. According to such arrangement, a light does not leak from the shielding common electrode 154.

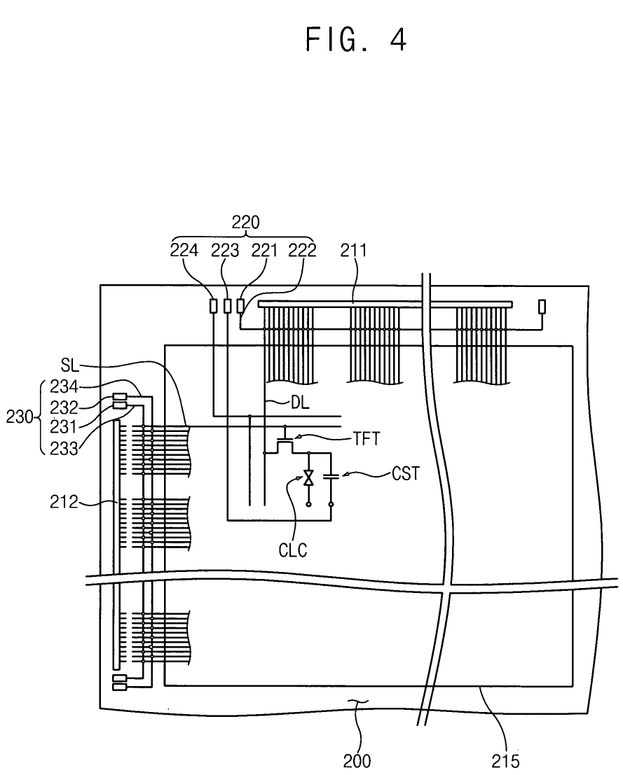

FIG. 4 is a plan view showing a main substrate having the array substrate shown in FIG. 1.

Referring to FIG. 4, the main substrate 200 includes a first shorting bar 211, a second shorting bar 212, a cutting line 215, a first array test part 220, and a second array test part 230.

The first shorting bar 211 may extend in the second direction, and connects with end portions of the data lines DL that extend in the first direction. The first shorting bar 211 blocks an electrostatic charge that may be provided from a source that is external to the main substrate 200. The first shorting bar 211 may be, for example, a single line.

The second shorting bar 212 may extend in the first direction and connects with end portions of the scan lines SL that may extend in the second direction. The second shorting bar 212 blocks the electrostatic charge that may be provided from a source that is external to the main substrate 200. The second shorting bar 212 may be, for example, a single line.

The cutting line 215 defines a plurality of display cells on the main substrate. Each display cell corresponds with one of the array substrates 100. The data lines DL, the scan lines SL, and the switching elements 110, are coupled with the data lines DL, scan lines SL, the storage capacitor CST, and the pixel parts 150, and formed on each of the display cells.

The first array test part 220 includes a data array pad 221, a data array line 222, a storage common electrode pad 223, and a shielding common electrode pad 224.

According to embodiment of the invention, the data array pad 221 is a 1D type. In the 1D type, a single test signal is commonly applied to the data lines DL. The data array line 222 is coupled with the data lines DL, therefore the test signal may be applied to the data lines DL through the data array line 222. Alternatively, the data array pad 221 may be a 2D type, a 3D type, . . . type such that a plurality of test signals may be applied to a plurality of groups of the data lines DL.

A storage common voltage VST may be applied to the second storage electrode 134 through the storage common electrode pad 223.

A shielding common voltage VSCOM may be applied to the shielding common electrode 154 through the shielding common electrode pad 224 or through a plurality of the shielding electrode pads 281. The test signal may be applied to the first shorting bar 211 to test the array substrate 100.

The second array test part 230 includes a first scan array pad 231, a second scan array pad 232, a first scan array line 233, and a second scan array line 234. In a 2G operation, a first test signal may be applied to odd numbered scan lines SL through the first scan array pad 231 and the first scan array line 233, and a second test signal may be applied to even numbered scan lines SL through the second scan array pad 232 and the second scan array line 234, or vice versa. According to an embodiment of the invention, the first array test part 220 may include the storage common electrode pad 223 and the shielding common electrode pad 224. Alternatively, the second array test part 230 may include the storage common electrode pad 223 and the shielding common electrode pad 224.

When testing the gate lines GL using the second shorting bar 212, a portion of each of the scan lines SL between the first and second scan array lines 233 and 234 and the second shorting bar 212 is opened so that the second shorting bar 212 disconnects from the first array scan line 233 and the second scan array line 234.

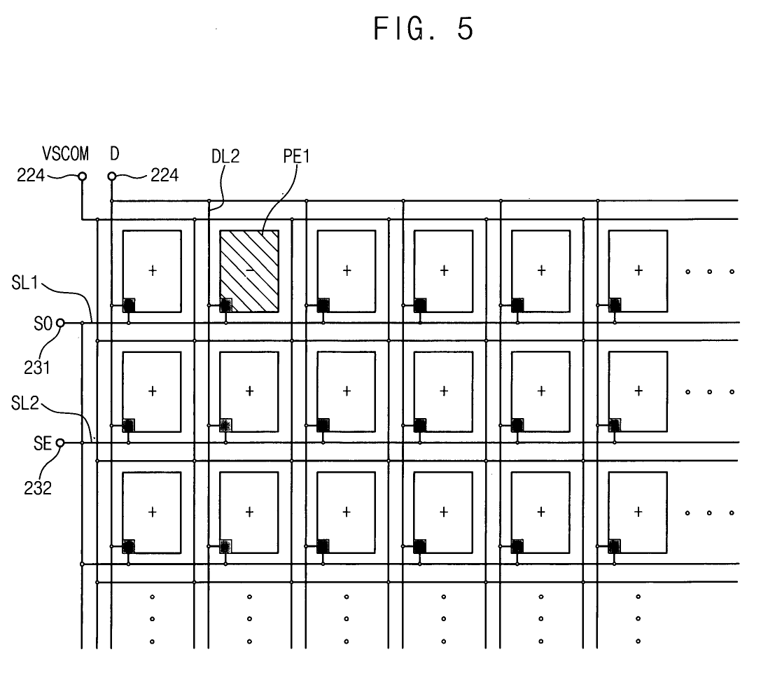

FIG. 5 is a plan view showing a test operation performed on the main substrate using an array test part shown in FIG. 4. The display cells are tested by applying test signals to the array substrate 100 through the first array test part 220 and the second array test part 230 to test the display cells.

Referring to FIG. 5, a data voltage D is applied to the first data array pad 221 and a shielding common voltage VSCOM is applied to the shielding common electrode pad 224. The shielding common voltage VSCOM has a different voltage level from the data voltage D. The storage common voltage is applied to the storage common electrode pad that is disconnected from the shielding common electrode pad 224.

A first scan signal S0 is applied to the first scan array pad 231 that is coupled with the odd numbered scan lines SL, and a second scan signal SE is applied to the second scan array pad 232 that coupled with the even numbered scan lines SL.

The data voltage D that is applied to the first data array pad 221 is positive. In the 1D type, for example, the data voltage D is applied to all of the data lines DL. The reference common voltage OV may be applied to the shielding common electrode pad 224. The reference common voltage OV has a different voltage level than the data voltage D.

An output voltage corresponding to each of the pixel electrodes 152 is checked to detect a malfunctioning pixel PE1.

The shielding common electrodes 154 and the pixel electrodes 152 may be formed from a same layer. Each of the shielding common electrodes 154 is spaced apart from each of the pixel electrodes 152 by a distance of about 5 μm to about 10 μm so that a short circuit may occur between the shielding common electrode 154 with the pixel electrode 152 by an impurity such as a particle, a dust, etc.

When the short circuit occurs between shielding common electrode 154 and the pixel electrode 152, the voltage level of the pixel electrode 152 changes and the malfunctioned pixel PE1 may be detected. For example, a summation of the voltages applied to the pixel electrode 152 and the shielding common electrode 154 is detected. According to an embodiment of the invention, the summation of the voltages has a negative polarity.

The shielding common voltage VSCOM has a different voltage level than the data voltage D and is applied to the shielding common electrode 154 so that the display cells of the main substrate 200 may be tested. It is understood that the display cells of the main substrate 200 may be tested using other methods, such as a 2D method, a 3D method, or the like.

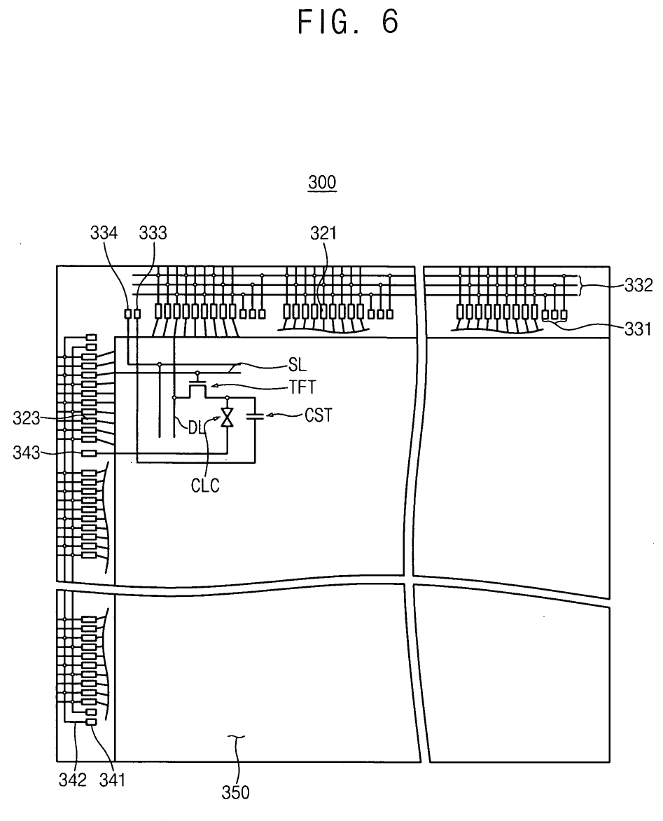

FIG. 6 is a plan view showing an LCD panel having the array substrate shown in FIG. 1.

Referring to FIG. 6, the LCD panel 300 includes an array substrate 310, a color filter substrate 350, and a liquid crystal layer (not shown) interposed between the array substrate 310 and the color filter substrate 350.

The array substrate 310 is on each of the display cells of the main substrate 200 (shown in FIG. 4). The array substrate 310 includes a pixel region, a first driving chip pad 321, a second driving chip pad 322, a first V/I test part, and a second V/I test part. The pixel region includes a plurality of data lines DL extend in a first direction, a plurality of scan lines SL extend in a second direction, a plurality of switching elements coupled with the data lines and the scan lines, a plurality of pixel electrodes that are first electrodes of liquid crystal capacitors CLC and a plurality of storage capacitors CST.

The first driving chip pad 321 is a contact terminal that contacts a bump or projection portion of a data driving chip, so that the first driving chip pad 321 is coupled with a group of the data lines DL. The second driving chip pad 322 is a contact terminal that contacts with a bump or a projection portion of a scan driving chip, so that the second driving chip pad 322 is coupled with a group of the scan lines SL.

The first V/I test part includes a data V/I pad 331, a data V/I line 332, a storage common electrode pad 333 and a shielding common electrode pad 334. According to embodiment of the invention, there may be three data V/I pads 331 and three data V/I lines 332. Each of the data V/I pads 331 is coupled with a (3n−2)th, a (3n−1)th or a 3n-th data line through each of the data V/I lines 332. A storage common voltage VST may be applied to first storage electrodes of the storage capacitors through the storage common electrode pad 343. A shielding common voltage VSCOM may be applied to shielding common electrodes through the shielding common electrode pad 334. The array substrate 300 may include a plurality of shielding common electrode pads 334.

The second V/I test part includes a scan V/I pad 341 and a scan V/I line 342. According to an embodiment of the invention, there may be two scan V/I pads 341, and two scan V/I lines 342. Each of the scan V/I pads 341 may be coupled with a (2n−1)th or a 2n-th scan line through each of the scan V/I lines 342.

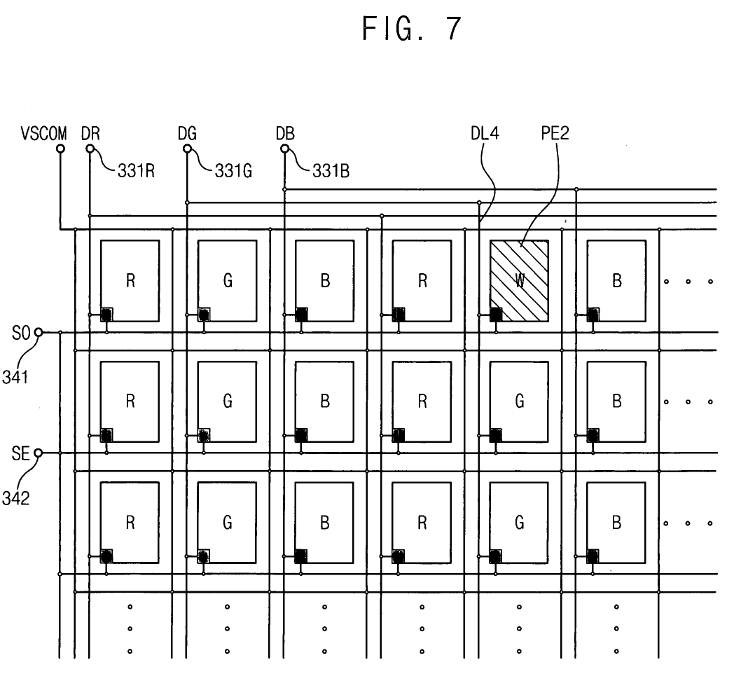

FIG. 7 is a plan view showing a V/I test operation performed on the LCD panel using a V/I test part shown in FIG. 6. In the V/I test operation, test signals are applied to the LCD panel to check images displayed on the LCD panel. Electrical and optical operations of the LCD panel are tested through the V/I test operation.

Referring to FIG. 7, a first data voltage DR, a second data voltage DG, and a third data voltage DB are applied to a first data V/I pad 331R, a second data V/I pad 331G, and a third data V/I pad 331B, respectively, and a shielding common voltage VSCOM is applied to the shielding common electrode pad 334. The shielding common voltage VSCOM has a different voltage level than the first data voltage DR, the second voltage DG, and third data voltage DB.

A storage common voltage VST may be applied to the storage common electrode pad that is coupled with the common electrode of the storage capacitor CST. A common voltage VCOM is applied to a common electrode pad that is coupled with the common electrode of the liquid crystal capacitor CLC. The color filter substrate may further include the common electrode. According to an embodiment of the invention, the test signals are independently applied to the shielding common electrode pad, the storage common electrode pad, and the common electrode pad.

Different test signals may be applied to the shielding common electrode pad, the storage common electrode pad and the common electrode pad.

A first scan signal S0 may be applied to the first scan V/I pad 341 that is coupled with the odd numbered scan lines SL, and a second scan signal SE is applied to the second scan V/I pad 342 that is coupled with the even numbered scan lines SL.

The first, second and third data voltages DR, DG and DB are applied to the first, second and third data V/I pads 331R, 331G and 331B, respectively. For example, in the 3D type, the first data voltage DR may be applied to (3n−1)th data lines. The second data voltage DG may be applied to (3n−2)th data lines. The third data voltage DB may be applied to 3n-th data lines. The first, second and third data voltages DR, DG, and DB may be simultaneously or sequentially applied to the (3n−1)th, (3n−2)th and 3n-th data lines, respectively.

A test voltage having a different voltage level they are of the first data voltage DR, the second data voltage DG, and the third data voltage DB is applied to the shielding common electrode pad 334. The test voltage may be a reference voltage.

For example, when the second data voltage DG is applied to the (3n−2)th data lines, the second data voltage DG is applied to a portion of the pixel electrodes that are coupled with the (3n−2)th data lines so that a voltage difference is formed between the pixel electrodes, which receive the second data voltage DG and the common electrode of the color filter substrate, which receives the reference voltage. An arrangement or orientation of a liquid crystal in the liquid crystal layer varies according to an electric field formed by the voltage difference, and thus a light transmittance thereof may change to display a green image.

When one of pixels that are coupled with the (3n−2)th data lines does not display the green image, the one of the pixels is determined a malfunctioning pixel PE2. The malfunctioning pixel PE2 may result from a short circuit formed between the pixel electrode and the shielding common electrode or between adjacent pixel electrodes.

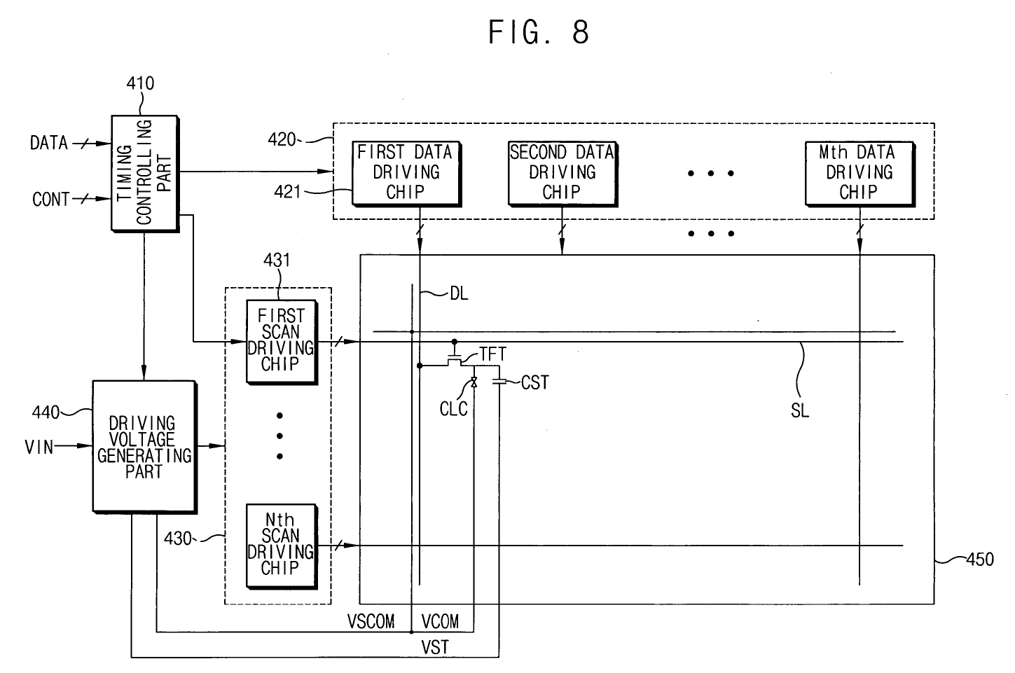

FIG. 8 is a block diagram showing an LCD device having the LCD panel shown in FIG. 7.

Referring to FIG. 8, the LCD device includes a timing controller 410, a data driver 420, a scan driver 430, a driving voltage generator 440 and an LCD panel 450.

The timing controller 410 controls the data driver 420, the scan driver 430, and the driving voltage generator 440 based on a control signal. That control signal may be provided from an external graphic controller (not shown).

The timing controller 410 may apply a horizontal start signal STH, an inversion signal RVS, a load signal TP, etc., to the data driver 130. The timing controller 410 may apply a scan start signal STV, a clock signal CK, an output enable signal OE, etc., to the scan driver 430. The timing controller 410 may apply a clock signal, an inversion signal RVS, etc., to the driving voltage generator 440.

The timing controller 410 processes and transmits externally provided data signals to the data driver 420.

The data driver 420 includes a plurality of data driving chips 421 that each process the data signals received from the timing controller 410. Each of the data driving chips 421 converts the data signals into analog signals based on the control signals provided from the timing controller 410. The analog signals are applied to data lines of the LCD panel 450.

The scan driver 430 includes a plurality of scan driving chips 431, and outputs scan signals to scan lines of the LCD panel 450 based on the control signal that is provided from the timing controller 410.

The driving voltage generator 440 generates scan voltages VON and VOFF, a common voltage VCOM, a shielding common voltage VSCOM, and a storage common voltage VST. The scan voltages VON and VOFF are provided to the scan driving part 430. The common voltage VCOM, the shielding common voltage VSCOM and the storage common voltage VST are provided to the LCD panel 450.

The storage common voltage VST may be applied to an electrode of the storage capacitor CST. The common voltage VCOM may be applied to the common electrode of the liquid crystal capacitor CLC. The shielding common voltage VSCOM is applied to a shielding common electrode that surrounds a pixel electrode and has a matrix or array like shape.

The shielding common voltage VSCOM has a voltage level that is substantially equal to the common voltage VCOM. According to an embodiment of the invention, the shielding common voltage VSCOM and the common voltage VCOM may be independently applied to the shielding common electrode and the common electrode, respectively.

The shielding common electrode overlaps each of the data lines so that a capacitor may be formed between the shielding common electrode and the data line. The shielding common voltage VSCOM and the common voltage VCOM may be independently applied to the shielding common electrode and the common electrode, respectively, to prevent the distortion of the liquid crystal in the liquid crystal layer. Although the data voltage is different from the common voltage VCOM, a level of the shielding common voltage VSCOM is not distorted.

The shielding common voltage VSCOM is substantially equal to the common voltage VCOM so that the normal display mode of liquid crystal layer between the shielding common electrode and the common electrode is black. For example, the shielding common electrode shields the data voltage and the black is displayed between the adjacent pixels by the shielding common electrode.

According to the above described embodiment of the invention, the storage common voltage VST may be substantially the same as the shielding common voltage VSCOM. However, it is understood that the storage common voltage VST may be different from the shielding common voltage VSCOM.

The LCD panel 450 includes an array substrate, a color filter substrate, and a liquid crystal that is provided between the array substrate and the color filter substrate. In particular, the array substrate may include a display region and a peripheral region. The display region includes a plurality of data lines DL, a plurality of scan lines SL and a plurality of pixels are formed in the display region. The data lines DL cross the scan lines SL. The pixels are defined by the data and scan lines DL and SL adjacent to each other. Each of the pixels includes a switching element that is a thin film transistor TFT, a liquid crystal capacitor CLC, a storage capacitor CST, and a shielding common electrode (not shown) surrounding the pixel and has a matrix shape.

The data driving chips 421 and the scan driving chips 431 are provided in the peripheral region of the array substrate. The data driving chips 421 apply the data signals to the data lines, and the scan driving chips 431 apply the scan signals to the scan lines. The data driving chips 421 and the scan driving chips 431 may be mounted or formed on the array substrate using pads that are formed on the array substrate. Alternatively, the data driving chips 421 and the scan driving chips 431 may be mounted or formed on the array substrate using flexible printed circuit boards (FPCB). The pads may include contact pads contacting the data driving chips 421 and the scan driving chips 431 and dummy pads. The dummy pads are electrically disconnected from the data driving chips 421 and the scan driving chips 431. The shielding common voltage VSCOM may be applied to the shielding common electrode of the LCD panel 450 through the dummy pads.

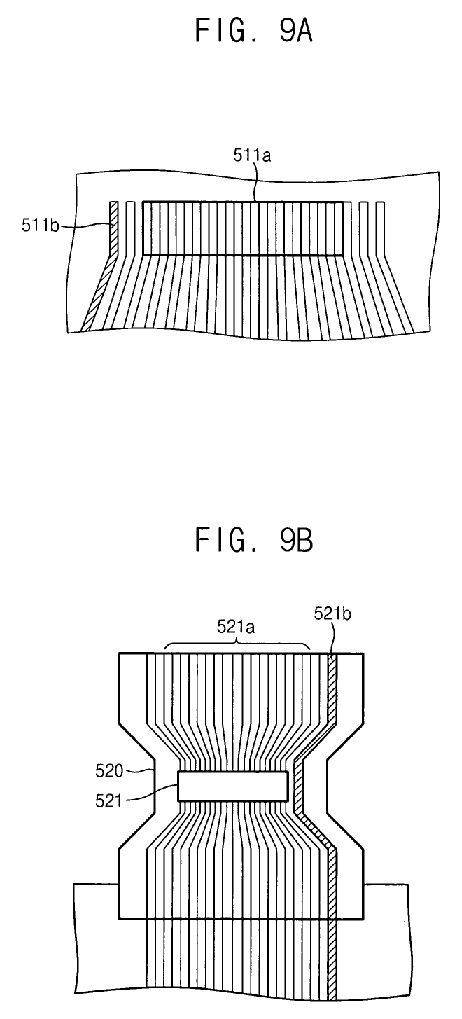

FIG. 9A and FIG. 9B are plan views showing pads shown in FIG. 8. FIG. 9A is a plan view showing a driving chip directly mounted or provided on the LCD panel.

Referring to FIGS. 8 and 9A, the LCD panel 450 includes the pads on which one of the data driving chips 421 and the scan driving chips 431 is provided on. The pads include contact pads 511a contacting bumps or projections of the driving chip and dummy pads 511b that are electrically disconnected from the bumps of the driving chip. The shielding common voltage VSCOM is applied to the shielding common electrode through the dummy pads 511b.

FIG. 9B is a plan view showing a driving chip mounted or provided on the LCD panel through the FPCB.

Referring to FIGS. 8 and 9B, the LCD panel 450 includes the pads on which the FPCB 520 is mounted or provided. The pads include contact pads 521a coupled with a driving chip 521 provided on the FPCB 520 through the FPCB 520 and dummy pads 521b that are electrically disconnected from the contact pads 521a. The shielding common voltage VSCOM may be applied to the shielding common electrode through the dummy pads 521b and the FPCB 520.

The shielding common voltage VSCOM may be applied to the shielding common electrode through the dummy pads to decrease the resistance of a conductive path through which the shielding common voltage VSCOM is applied. The conductive path may include the driving voltage generating part, the dummy pads, and the shielding common electrode.

The data driving chip may be mounted or provided on the FPCB 520. The scan driving chip may also be mounted or provided on the FPCB 520.

According to an embodiment of the invention, the array substrate includes the shielding common electrode, which shields the pixel electrode from an electromagnetic interference formed by the data voltage applied to the data line. The shielding common voltage applied to the shielding common electrode has different level from the data voltage applied to the data line so that the array substrate is tested through a ID method.

In addition, in the V/I test process, the shielding common voltage applied to the shielding common electrode is different than the data voltage applied to the data line.

The shielding common voltage is applied to the shielding common electrode through the dummy pads to decrease the resistance of the conductive path through which the shielding common voltage is applied. The shielding common voltage is independently applied to the shielding common electrode from the storage common voltage and the common voltage to prevent distortion of the shielding common voltage, e.g., keeping the shielding common voltage constant.

Therefore, the constant shielding common voltage is applied to the shielding common electrode to shield the pixel from the data voltage and decreases the leakage of the light between the adjacent pixels.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An array substrate comprising:
a substrate comprising:
a plurality of data and scan lines that define an area for a pixel electrode to be formed and a shielding common electrode surrounding the pixel electrode,
a data tester applying a test data voltage to the data lines, and
a shielding common electrode pad applying a shielding common voltage having a voltage level that is different from the test data voltage to the shielding common electrode.

2. The array substrate of claim 1, wherein the shielding common electrode is formed on an area of the substrate region corresponding to the data and scan lines and has a matrix shape.

3. The array substrate of claim 1, wherein the shielding common electrode is formed on an area of the substrate corresponding to the data lines.

4. The array substrate of claim 1, wherein the data test part comprises:
a plurality of pads receiving a plurality of test data voltages; and
a plurality of lines coupled with the pads, respectively.

5. The array substrate of claim 1, further comprising:
a common electrode pad through applying a test common voltage to a counter electrode corresponding to the pixel electrode.

6. The array substrate of claim 1, further comprising:
a scan tester applying a test scan voltage to the scan lines, the scan tester comprising:
a plurality of pads applying a plurality of test scan voltages to the scan lines, and a plurality of lines coupled with the pads, respectively.

7. A main substrate comprising:
an array substrate comprising a substrate having a pixel electrode provided in an area defined by a plurality of data and scan lines and a shielding common electrode surrounding the pixel electrode;
a data tester applying a test data voltage to the data lines; and
a shielding common electrode pad applying a test shielding common voltage to the shielding common electrode.

8. The main substrate of claim 7, wherein the data test part comprises:
a plurality of pads applying a plurality of test data voltages to the data lines; and
a plurality of lines coupled with the pads, respectively.

9. The main substrate of claim 7, further comprising:
a scan tester applying a test scan voltage to the scan lines, the scan tester comprising:
a plurality of pads applying a plurality of test scan voltages, and
a plurality of lines coupled with the pads, respectively.

10. The main substrate of claim 7, further comprising:
a display region comprising the pixel electrode; and
a peripheral region surrounding the display region and comprising the data tester and the shielding common electrode pad.

11. The main substrate of claim 7, further comprising:
a storage capacitor coupled with the data and scan lines, and
a storage common electrode pad applying a test storage common voltage to a common electrode of the storage capacitor.

12. The main substrate of claim 7, wherein the pixel electrode comprises:
an opening extending in a predetermined direction.

13. The main substrate of claim 12, wherein the opening is substantially symmetrical with a central line of the pixel electrode that is substantially parallel with the scan lines.

14. A liquid crystal display device comprising:
a display panel comprising a switching element, a liquid crystal capacitor, a storage capacitor, a pixel electrode, and a shielding common electrode surrounding the pixel electrode;
a driver applying a driving signal to the display panel; and
a driving voltage generator applying a common voltage to the liquid crystal capacitor and applying a shielding common voltage to the shielding common electrode.

15. The liquid crystal display device of claim 14, wherein the driving voltage generator applying a storage common voltage to the storage capacitor.

16. The liquid crystal display device of claim 14, wherein the driver comprises:
a scan driver applying a scan voltage to a control electrode of the switching element; and
a data driver applying a data voltage to a source/drain electrode of the switching element.

17. The liquid crystal display device of claim 14, wherein the shielding common voltage is substantially equal to the common voltage, and
wherein the shielding common voltage and the common voltage are independently applied to the shielding common electrode and the liquid crystal capacitor, respectively.

18. The liquid crystal display device of claim 14, wherein the driving part comprises a plurality of driving chips, and
wherein the display panel comprises a plurality of contact pads contacting the driving chips and a dummy pad disconnected with the driving chips.

19. The liquid crystal display device of claim 18, wherein the shielding common voltage is applied to the shielding common electrode via the dummy pad.

20. The liquid crystal display device of claim 18, wherein the display panel comprises a plurality of dummy pads applying the shielding common voltage to the shielding common electrode.
